(19) United States
(12) Patent Application Publication
(10) Pub. No.: US 2013/0339169 A1
(43) Pub. Date: Dec. 19, 2013

(54) METHOD AND SYSTEM FOR MANAGING DYNAMIC PRICED OFFERS UTILIZING CONDITIONAL PLEDGING

(71) Applicant: Elan Binyamin PERACH, Raanana (IS)

(72) Inventor: Elan Binyamin PERACH, Raanana (IS)

(21) Appl. No.: 13/910,339

(22) Filed: Jun. 5, 2013

Related U.S. Application Data
(60) Provisional application No. 61/660,959, filed on Jun. 18, 2012.

(51) Int. Cl. G06Q 30/06

(52) U.S. Cl. CPC G06Q 30/0605
USPC 705/26.2

(57) ABSTRACT

A method and system for group having and selling is provided, where dynamic priced offers are managed utilizing conditional pledging. In some embodiments, a dynamic priced offer management system includes an end user communication device in data connection with the system server, the server including a file with instructions to execute commands to enable execution of the offer management, a system database including is memory having stored thereon system data, offer data, and user data; a dynamic pricing module including instructions to execute commands to enable dynamic price offer management and a conditional pledging module including instructions to execute commands to enable conditional pledging.

### CROSS REFERENCE TO RELATED APPLICATIONS

This application claims priority from U.S. Provisional Patent Application No. 61/660,959 filed Jun. 18, 2012, entitled “METHOD AND SYSTEM FOR MANAGING DYNAMIC PRICED OFFERS WITH CONDITIONAL PLEDGING”, which is incorporated in its entirety herein by reference.

### FIELD OF THE INVENTION

The present invention details methods and devices useful in commerce, and more specifically, embodiments of the invention and how they relate to systems, methods and apparatuses that enable dynamic priced offers in online commerce.

### BACKGROUND OF THE INVENTION

There are currently two primary methods utilized for selling and managing group buying offers: fixed priced group offers and dynamic priced group offers.

Fixed priced group offers provide a fixed price on a purchase if a minimum number of offers are achieved. This model is based on various budgetary considerations and a minimum expected turnout. If the minimum requirements are not achieved by the deadline, the offer is canceled. Whereas this strategy may prevent a loss on a low turnout, it may miss out on potential profits had the price been even lower.

Dynamic priced group offers allow for decreasing price as more people purchase an offer, as long as the minimum purchase requirements are met. This model is based on a minimum and maximum price, minimum and maximum number of offers and an offer deadline. If the minimum requirements are not achieved by the deadline, the offer is canceled. While this model allows for greater flexibility than the fixed price model, it may result in lower profits due to the fact that people are likely to wait for the price to decrease without ever making pledge. In the worst case, the offer may expire without ever achieving the minimum requirements. Both of these models may be used to sell goods, services or events.

Managing an event group offer with the fixed pricing model offers more flexibility than it does for goods or services because events usually have a fixed expense per group, while products and services may have an expense per consumer. It creates an opportunity for the seller to start giving discounts once they have achieved their initial minimum expected turnout. However, this may result in a situation where attendees are bothered that some people probably paid less, which could result in loss of future profits due to buyers remorse and bad word-of-mouth.

Event group offers utilizing dynamic pricing may allow much greater pricing discount options compared to product or service offers utilizing dynamic pricing. Since event expenses do not significantly increase as additional people register, organizers may be more flexible within the pricing model, which may result in increased profit margins due to increased sales at lower profit margins.

Today there are many event and group buying management tools that enable sellers to manage their group purchase offers, but none of them overcome all of the obstacles mentioned above.

### SUMMARY OF THE INVENTION

There is provided, in accordance with an embodiment of the present invention, a system, and method for managing, buying and selling dynamic priced offers, where there is an option for consumers to pledge a price lower than the “current price” and only if and when the offer reaches their chosen pace will their pledge become active. This is referred to hereinafter as “Conditional Pledging”.

A system and methods for group buying and selling is provided, where dynamic pricing offers may be managed, optionally with conditional pledges. Dynamic pricing offers may include dynamic price step(s), a payment collection date, payment receiver(s), and optionally pioneer discount(s). Buyers may pledge to make a purchase either as a pioneer pledge, definite pledge or conditional pledge, such that if the offer requirements are met, all of the potential buyers who pledged at least the final price, will get charged, in accordance with the dynamic price chart on the payment collection date.

In accordance with some embodiments, the system and methods may enable sponsorship management, for external parties to sponsor or cover the cost of buyer pledges.

According to some embodiments, multiple Dynamic Pricing Chart User Interfaces are provided, for example, for creating dynamic priced offers and for making pledges on dynamic priced offers, including elements described in the text and drawings herein.

According to some embodiments, methods are provided for managing dynamic priced conditional offers and/or pledges, using a Dynamic Chart User Interface, including elements described in the text and drawings herein.

A method and system for group buying and selling is provided, were dynamic priced offers may be managed, optionally with conditional pledges. In some embodiments, a dynamic priced offer management system includes an end user communication device in data connection with the system server, the server including a file with instructions to execute commands to enable execution of the offer management; a system database including a memory having stored thereon system data, offer data, and user data; a dynamic pricing module including instructions to execute commands to enable dynamic price offer management; and a conditional pledging module including instructions to execute commands to enable conditional pledging.

In some embodiments, the dynamic priced offer management system includes an offer sponsorship module including instructions to execute commands to enable offer sponsorship management.

In some embodiments, the dynamic priced offer management system includes a marketplace adapted to allow merchants to collect revenues from dynamic priced group offers.

In some embodiments, the dynamic priced offer management system includes a dynamic discounting module.

In some embodiments, the dynamic priced offer management system includes a dynamic expense management module.

In some embodiments, the dynamic priced offer management system includes a dynamic payment receiver module.

According to some embodiments of the present invention, a method is provided for enabling dynamic priced offer management, including running one or more files with instructions to execute commands to enable conditional pledging, including: generating a purchase offer, by a seller; generating a purchase pledge(s), by a potential buyer; querying on the payment collection date, whether the offer requirements, and/or the pledge conditions, are met; if the offer requirements are met, then calculating how many applicable pledges meet the requirements, and calculating the final price per buyer; and if the oar requirements are not met, then the system ends the offers process with no deal.

In some embodiments, the method may include charging buyers together and transferring the funds to the seller(s).

In some embodiments, the method may include querying whether one or more buyers have a pioneer discount a cash discount, and/or other price changing element.

In some embodiments, the pledge may include one or more variables, including pioneer pledges, definite pledges, pledges wanted, max attendees limit and/or an offer follow requirement.

In some embodiments, the potential buyer pledges may optionally include one or more pledge conditions.

In some embodiments, the potential buyer may stipulate multiple possible conditions which must be met in order for the pledge to he executed.

In some embodiments, a sponsor makes a pledge on behalf of one or more buyers.

In some embodiments, a sponsor generates related terms and conditions for executing the pledge on behalf of a buyer.

In some embodiments, multiple potential buyers choose the maximum price they are willing to pay, wherein only if then conditions are met will their payment be charged.

In some embodiments, the method may include adding one of more dynamic expenses to the purchase offer.

In some embodiments, the method may include adding one or more dynamic payment receivers to said purchase offer.

According to some embodiments of the present invention, an e-commerce tool is provided for enabling dynamic price offer generation, comprising: an interactive dynamic graphical interface including a dynamic drag and drop feature for determining the price of the offer per number of buyers; a range input tool to enable the minimum and maximum number of buyers; and a profit calculation tool including an expense calculator to provide graphical interface to display planned profits for the offer per number of buyers.

In some embodiments the expense calculator is a dynamic expense interface based on a selected expense level for a selected number of buyers.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1A is a schematic block diagram of components of a system for managing dynamic priced offers with Conditional Pledging, according to some embodiments;

FIG. 1B is a schematic block diagram of components of a system for managing dynamic priced offers with Conditional Pledging and fledge Sponsors, according to some embodiments;

FIG. 2 is a flowchart illustrating in example of a process for managing dynamic priced offers with conditional pledging, according to some embodiments;

FIG. 3 is an example of a screen-shot that describes an example of a screen to browse dynamic priced offers, according to some embodiments;

FIG. 4 is an example of a screen-shot that describes a basic sign up form, which in this example, integrates PayPal data and authorization, according to some embodiments;

FIG. 5 is an example of a screen-shot that describes an example of a profile page, according to some embodiments;

FIG. 6 is an example of a screen-shot that describes a dynamic priced offer generation interface, according to some embodiments;

FIG. 7 is an example of a screen-shot that describe an example of elements for managing and planning the dynamic price step(s) of an offer, according to some embodiments;

FIG. 8 is an example of a screen-shot that describes an example of a pioneer discount pricing setting window, according to some embodiments;

FIGS. 9A-9B are examples of screen-shots that describe an expense management mechanism, to optionally enable dynamic expense management, according to some embodiments;

FIGS. 10A-10B are examples of screen-shots that describes a mechanism for organizing and adding multiple payment receivers for an offer, to optionally enable dynamic payment receiver management, according to some embodiments;

FIG. 11 is an example of a screen-shot that describes an example of an offer review before launching it to the public that integrates the price pat number of buyers, income per number of buyers and pioneer discounts, according to some embodiments;

FIG. 12 is an example of a screen-shot that describes an example of an offer as it may be presented to potential buyers, according to some embodiments;

FIG. 13 is an example of a screen-shot that describes an example of a pledge tracking mechanism, according to some embodiments;

FIG. 14 is an example of a screen-shot that describes an example of a course wanting tracking mechanism, according to some embodiments;

FIG. 15 is an example of a screen-shot that describes the sponsorship management mechanism, according to some embodiments,

FIG. 16 is an example of a screen-shot that describes an example of a dynamic price chart that may be used for plotting, following and/or managing a definite pioneer pledge, according w some embodiments;

FIG. 17 is an example of a screen-shot that describes an example of a tracking mechanism for a Conditional pledge, according some embodiments;

FIG. 18 is an example of a screen-shot that describes an example of a payment authorization interface, which may be provided by a third party online payment solution, according to some embodiments;

FIG. 19 is an example of a screen-shot that describes an example of an offer management tracking mechanism that integrates the option of embedding the offer in an external location, according to some embodiments;

FIG. 20 is an example of a screen-shot that describes an example of a pledge management tracking mechanism for a seller, for optionally tracking and updating multiple pledges for an offer, according to some embodiments;

FIG. 21 is an example of a screen-shot that describes an example of a pledge management trucking mechanism, for a buyer to manage multiple pledges, according to some embodiments;

FIG. 22 is an example of a screen-shot that describes an example of a dynamic pricing tool for creating an offer, according to some embodiments;

FIG. 23 is an example of a screen-shot that describes an example of a dynamic pricing chart tool for a pledger to view the prices at different price points as well as choose the price they want to pledge, according to some embodiments; and

FIG. 24 is an example of a screen-shot that describes an example of a graphical user interface for planning dynamic priced offers, including a tool for calculating expenses and profits per number of potential buyers.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The phrase “dynamic priced oilers” as used herein may refer to situations where a merchant determines a minimum price, maximum price, minimum sales, maximum sales and a deadline for a group buying offer or sale, such that if the minimum number of pledges is achieved before or by the deadline, the offer is activated and every pledge after that brings the price down gradually. The term “conditional pledging” as used herein may refer to a pledger who will commit to making a purchase at a price that is lower than the next pledge price IF their chosen price becomes applicable.

Embodiments of the present invention enable managing of dynamic priced offers or sales in a group buying and/or selling environment, where dynamic priced offers may be managed with conditional pledging.

According to smite embodiments, a method is enabled for implementing Conditional pledging on dynamic priced offers. For example, a system is provided to allow consumers to make a conditional payment for a dynamic priced group offer, while choosing the maximum price they are willing to pay, wherein only if their conditions are met will their payment be charged. In general, everyone who gets charged may be charged the same amount, yet in other examples, differential pricing may be used, such as extra discounts for early birds and other forms of promotion and incentive giving.

In some embodiments, a Marketplace is provided where merchants may offer dynamic priced group offers in various categories, manage, the registrations and/or pledges to their offers and collect the more through the platform (like ebay).

In further embodiments, an API and set of plug & play tools is provided that allows developers to easily create and integrate Conditional pledging on dynamic priced offers in their software applications. For example, an eCommerce website which would like to develop an extra section of a weekly deal utilizing such Conditional pledging on dynamic priced offers, would be capable of doing so with little programming effort while using the API.

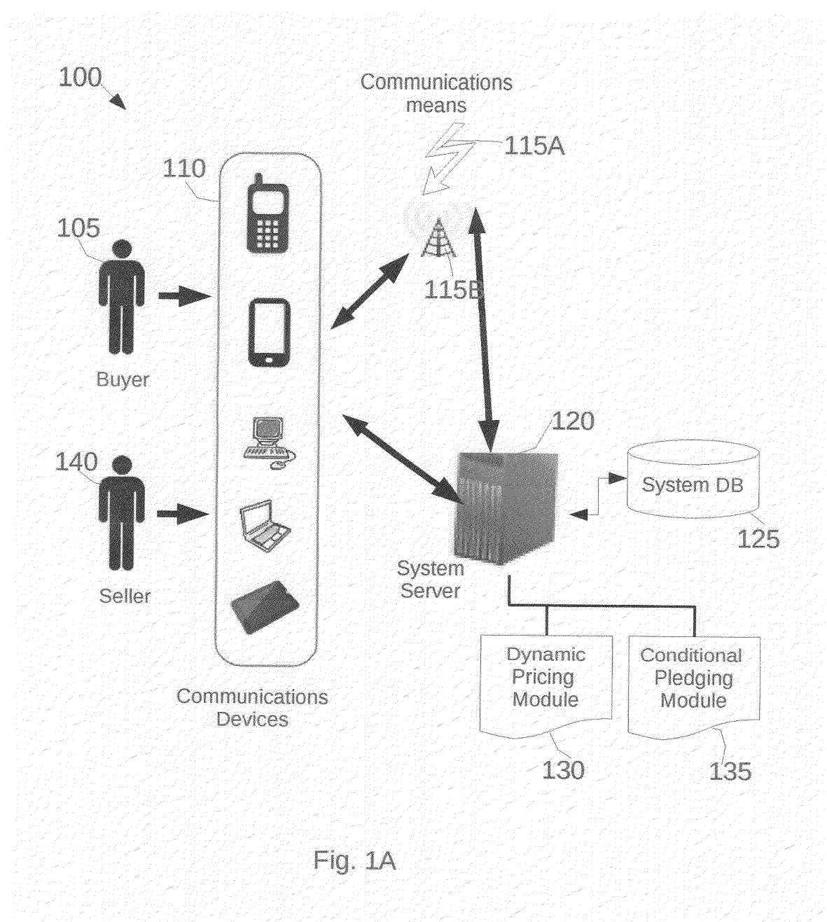

Reference is now made to FIG. 1A which is a schematic block diagram of components of a platform or system 100 for managing dynamic priced offers, according to some embodiments. As can be seen in FIG. 1A, the system may include a buyer 105, commanding or communicating his or her requirements with one or more communications devices 110. System 100 may further include a seller or offer provider 140, commanding or communicating his or her requirements with one or more communications devices 110. Communications device(s) 110 can transmit commands or instructions to system server 120, via communications mediums 115, whether via wired 115A or wireless 120 means. Server 120 may provide one or more user interface types, codes, files etc. for enabling system users to access and interact with server 120, such that sellers 140 and buyers 105 may enter commands, instructions and/or communications with one or more communications devices 110. Server 120 includes a dynamic pricing module 130, for example, code, software, application and/or algorithm. Server 120 optionally include conditional pledging module 135, for example, code, software, application and/or algorithm. Server 120 is in general communicatively coupled to database 125.

In some embodiments, price steps allow seller 140 to determine the price of an offer for any given amount of sales with great flexibility. A first price step configuration is hereinafter referred to as “Dynamic Price Step”, wherein the offer owner predetermines the prices of the offer between a range of sales and that results in their final income. A second price step configuration is hereinafter referred to as “Dynamic Income Step”, wherein the offer owner predetermines the final income for a given range of offers and the resulting prices. In some embodiments, the Dynamic Payment Receiver income may be designed to allow the seller determine a dynamic income for one or more payment receivers. For example, a course organizer may pre-determine differential payments to multiple payment receivers, such as teachers and facility providers etc.

In some embodiments, the dynamic price steps include a minimum price, maximum price, minimum sales, maximum sales and step type (e.g., drop step or linear step). The Linear price steps, for example may decrease the price of the offer in a linear fashion each time another offer is made the price drops accordingly. The Drop price steps, for example, may decrease the price of a group offer only once the maximum sales # of the step is achieved.

In some embodiments, the system buyer(s) 105 may pledge funds to cover a potential purchase, such that the pledge is defined as pre-approved payment that allows the system to automatically charge the buyer or pledger within the pre-approved amount and within a predetermined date range. In some examples, a pledge may be secured with a third party on-line or off-line payment solution, such as credit card, PayPal, Amazon payments etc. In other examples a cash pledge may be made.

In the case of pre-approved on-line payments, the buyer or consumer may be required to go through a process where they are expected to pre-approve the application to charge them automatically for a given sum during a later date with the use of an on-line payment solution. For example, in the case of cash pledges, the system may require the buyer to transfer funds to a trust or escrow type account, wherein the funds can only be extracted if the purchase offer gets completed.

In the case of cash pledging, the buyer may be given the option to pay with cash off-line, instead of with an on-line payment solution. Cash pledging may reduce the seller's commissions to on-line payment solution providers and allow them to give an extra “cash payment discount” for paying with cash. When using a cash pledge, this may be executed by requesting a backup on-line pledge, in addition to the cash pledge, in case the buyer never pays the cash. Any buyer who chooses to pay cash will in general need to pay after the offer pledging deadline and before the group offer payment collection date, otherwise the system will charge them automatically through the on-line payment pledge option they already pre-approved. If a person does pay with cash, the offer owner can update their payment status to “paid” in the system which will cancel the on-line pledge. In other cases, there may be no pledging deadline, in which case the final price of the offer may continue to change at any time from when the offer went active, till the payment collection date. In such cases where the price paid by the cash buyer is higher than the final price, the offer owner may refund the difference to the cash buyer either with an on-line payment solution or with cash.

In some embodiments, buyer 105 max stipulate multiple possible conditions which must be met in order for a pledge made to be executed. For example, the buyer may determine multiple conditional pledges on a single offer or multiple offers. In another example, the buyer may determine a maximum sales/attendees/people limit to his/her pledge, such that if the final number of sales is over it chosen maximum sales limit their pledge will not be counted.

Reference is now made to FIG. 1B which is a schematic block diagram of components of a system for managing dynamic priced offers with Conditional Pledging, and optionally adapted to allow offer sponsorships, according to some embodiments. As can be seen in FIG. 1B, system 100 may further include a sponsor or patron 160, who may, for example, decide to pledge on behalf of one or more users. System 100, in this case, may include a sponsorship module 165 being executed by server 120. For example, the sponsorship module 165 may facilitate the fixing of sponsorship terms and conditions. In another example, the sponsorship module 165 may provide a negotiating tool, code or application to enable terms and conditions to be negotiated, confirmed changed etc. In our example, a sponsorship mediator may be integrated into the sponsorship negotiations, for example, to mediate disputes and/or settle outstanding queries.

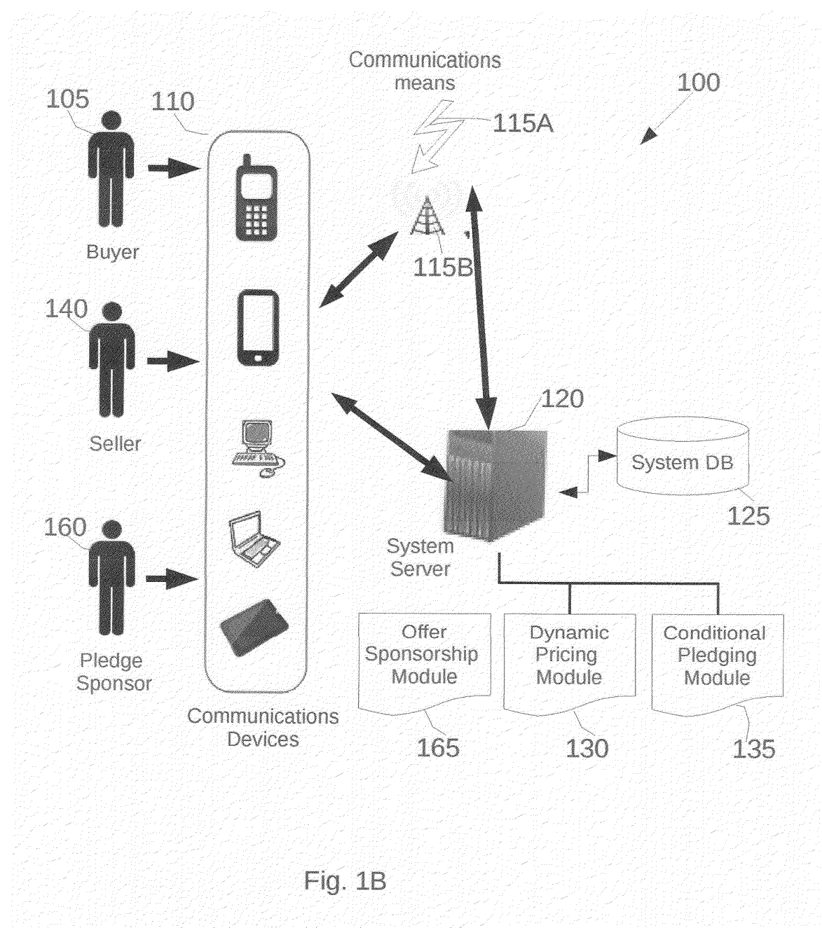

Reference is now made to FIG. 2, which is a flowchart illustrating an example of a process for managing dynamic priced offers with conditional pledging, according to some embodiments. As can be seen in FIG. 2, the process may include, at step 200, a seller generating a purchase offer, for example a product, service or event ect. A purchase offer may include, for example, dynamic price step(s), a payment collection date, payment receiver(s) and optionally pioneer discount(s) etc. At step 205 the system starts the offers process for the purchasing offer, which is referred to as the start date. At step 210, one or more buyers may generate a purchase pledge(s), which may include, for example, one or more of pioneer pledges, definite pledges, pledge want, max attendees limit and/or an offer follow requirement. Buyer pledges may optionally include one or more pledge conditions. For example, a buyer may pledge to purchase an offer on condition that the final price is equal to or lower than their specified pledge price. In still further embodiments, the buyer may stipulate multiple possible conditions which must be met in order for the pledge to be executed. If their pledging conditions are met then the purchase of the offer may be automatically executed, whereas if the pledging conditions are not met then the purchase of the offer may be automatically nullified or delayed. In some embodiments, a sponsor may elect to make a pledge on behalf of one or more buyers. In some cases, the sponsor may generate sponsor related terms and conditions for executing a pledge on behalf of a buyer. At step 215 the system ends the offers process on the payment collection date. At step 220, the system queries, on the payment collection date, whether the offer requirements, optionally including the pledge conditions, are met. If these requirements are met, then at step 225, the system calculates how many applicable pledges meet the requirements and calculates the final price per buyer. At step 230, the system queries whether one or more buyers have a pioneer discount and/or a cash discount etc. At step 235, the system charges everyone together (except for the cash pledgers) and transfers the funds to the seller(s). At step 220, if the offer requirements are not met, then the system ends the offers process with no deal, at step 240. Any combination of the above steps may be implemented. Further, other steps or series of steps may be used.

Embodiments of the present invention may include concepts or terms, which may be defined as follows:

Pioneers—refers to the first group of people to make a “definite pledge”. This method is put at place to help incentivize the first pledgers of an offer in order to get the offer rolling to a stage where the increased number of pledges causes the price to start decreasing.

Pioneer Discount—is the extra, discount in addition to the final price given only to people who pledged as pioneers.

Pioneer Discount Steps—may allow the offer creator to determine different pioneer discount incentives according to how many people pledged. Meaning the pioneer discount max decrease as more people pledge, making it more attractive to pledge as a pioneer early. These steps may consist of linear discount steps and/or drop discount steps. Each discount step may be a percentage discount or predetermined sum discount.

Offer Status—if enough pledges accomplish the requirements of any step of the dynamic price chart of an offer, the offer status is active. Before that time, the offer status is pending. If the offer status is pending on the payment collection date, the offer may be canceled.

Current Price—refers to the lowest possible applicable price that a combination of pledges accomplishes, according to the dynamic price chart of an offer.

Next Pledge Price—refers to the lowest possible pledge amount necessary in order to achieve the next lowest possible “current price” according to the dynamic price chart that will either turn the offer status to “Active” from “Pending” or keep it “Active”. If there are no pledges at all the “Next Pledge Price” is equal to the Max Price.

Final Price—refers to the current price determined on the offer payment collection date.

Definite Pledge—refers to when a person is willing to pledge a the next pledge price. If the offer is not yet active and there are no pledges than a definite pledge would be the maximum price.

Pioneer Pledge—refers to a “definite pledge” that is eligible to receive a “Pioneer discount” off the final price.

Conditional Pledge—refers to when a person is willing to pledge they will make the purchase at a price they determine which is lower than the next pledge price IF their chosen price becomes applicable.

Maximum People Condition—refers to when a buyer determines they will only pledge if the final number of people who pledge is under or equal to their chosen maximum number. This condition may be applied to any type of pledge, such as definite, pioneer, and conditional etc.

Multiple Payment Receivers—Offer owners may determine multiple payment receivers and split the payments either according to percentage of the total income, predetermined sums or dynamic based compensation according to how many offers were made.

Offer Want—refers to when a buyer wants to let the world know what they would like to purchase, and/or would be happy if someone else would make a pledge in their name.

Offer Follow—refers to when a buyer would like to get updates via email, Facebook notifications, tweets etc as more people pledge for the offer of their interest and/or the price of the offer changes.

Pledge Sponsorship—refers to when a person makes a pledge on behalf of someone else. The pledge may be with or without terms and conditions and/or mediator suggestion(s). An example could be someone who wants to know what a friend of their wants to buy and checks out their friends “Wants” and makes a pledge on their behalf. Another example may be a company who is looking for a worker and views all the people who want to sign up for a course that will be teaching the skills needed for the position. The company may then make a sponsored pledge on behalf of someone who looks promising and add “terms and conditions” as well as a “mediator” in order to better manage the deal. The person getting sponsored may then accept, edit or decline the deal. If accepted both parties may need to make a pledge and if there is a dispute the mediator may control who's pledge will be charged.

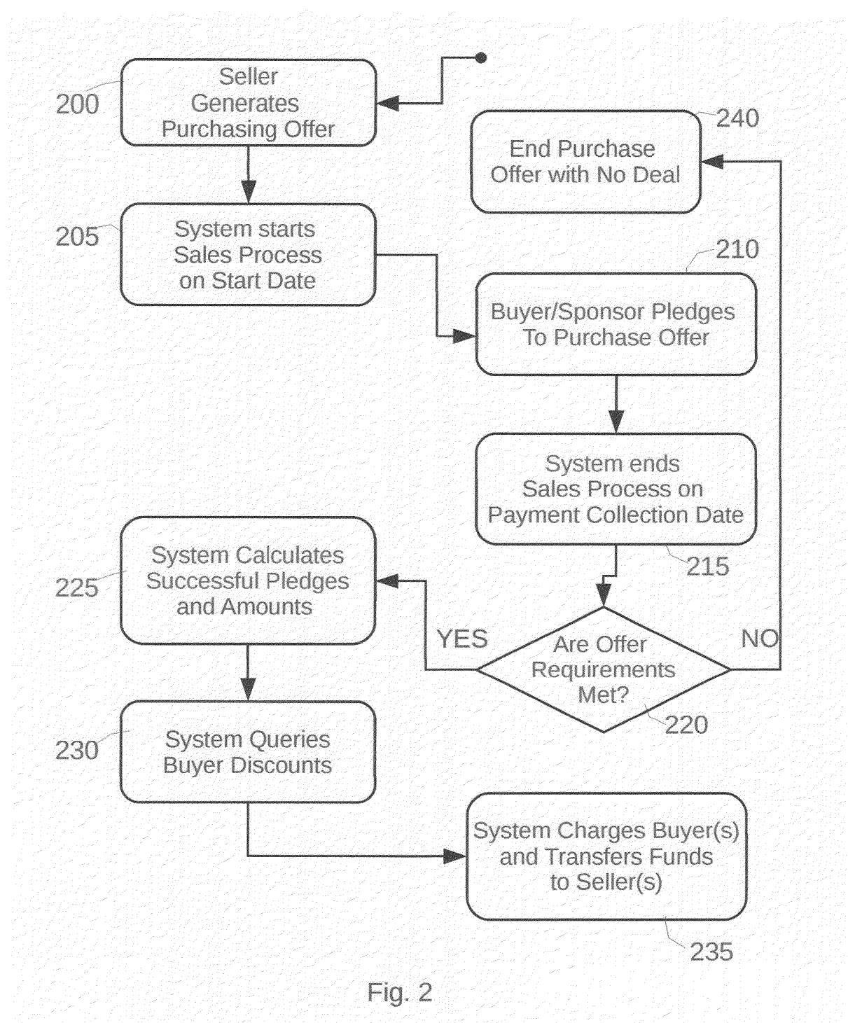

Reference is now made to FIG. 3, which is an example of a screen-shot that describes an example of a screen to browse dynamic priced offers. As can be seen, offers may be classified according to type, category, location and price etc., thereby allowing user filtering of search results in accordance with one or more classifications. Other elements of the offers that can be seen in the figure include the dynamic price range, the pledged amount by one or more buyers, the offer status, the next pledge price, the current price, and the pioneer discount offered by the seller to early pledgers.

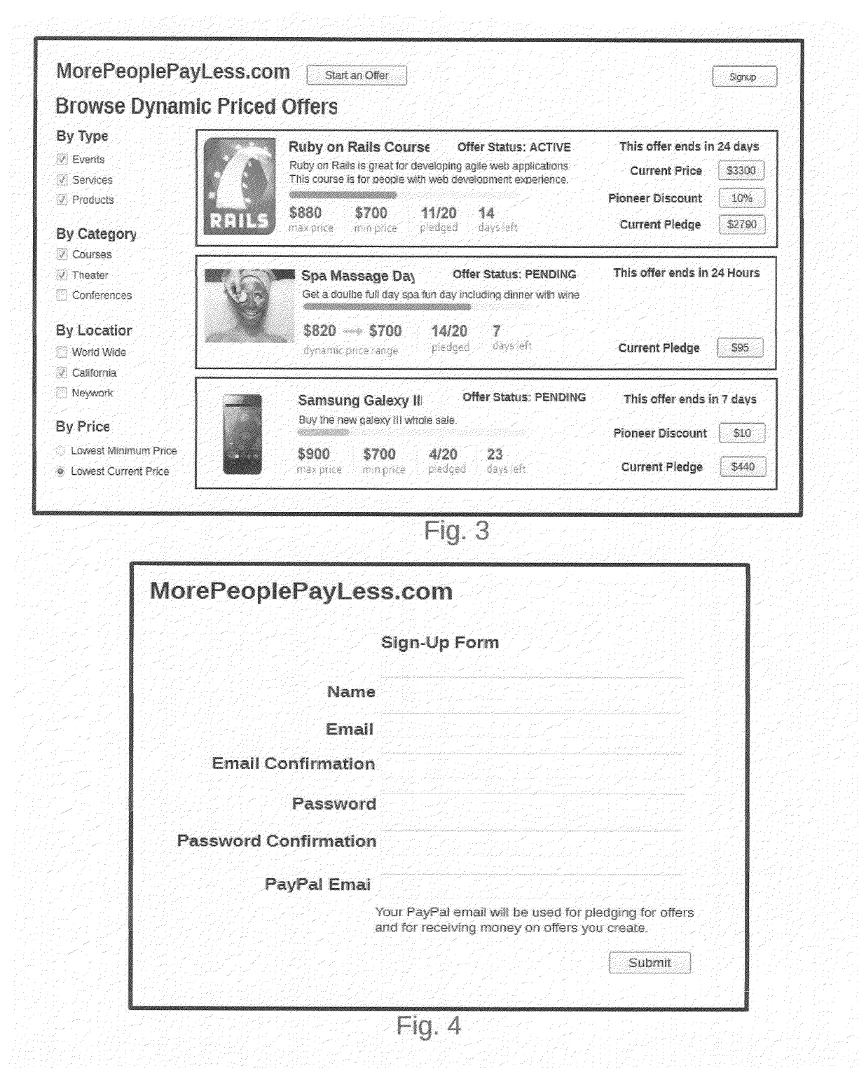

Reference is now made to FIG. 4, which is an example of a screen-shot that describes a basic sign up form, which in this example, integrates PayPal data and authorization, such that payments may be made to and received from a user's Paypal account.

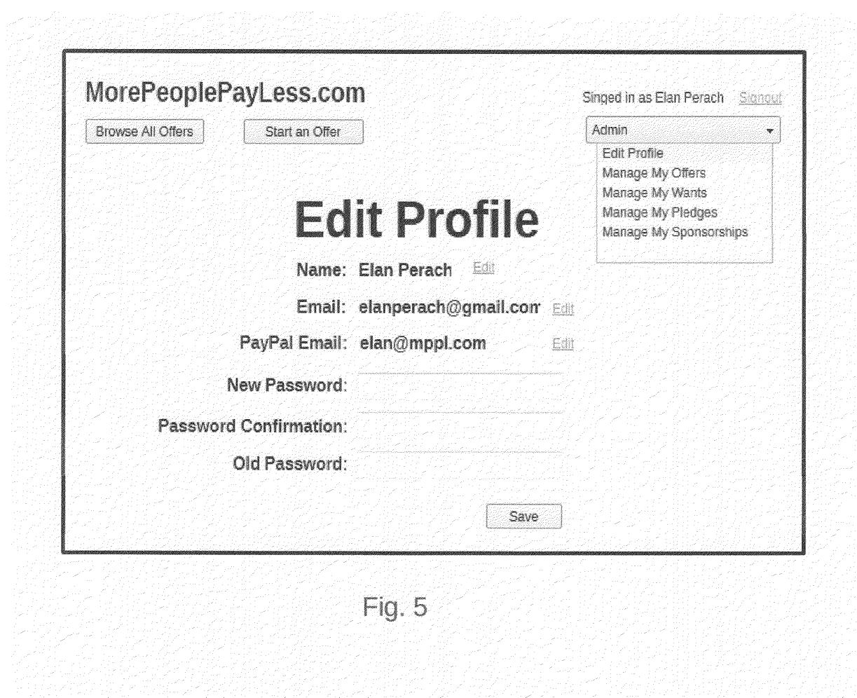

Reference is now made to FIG. 5, which is an example of a screen-shot that describes an example of a profile page. As can be seen, a user's profile may enable user activity as a seller, a buyer, a pledger, and a sponsor.

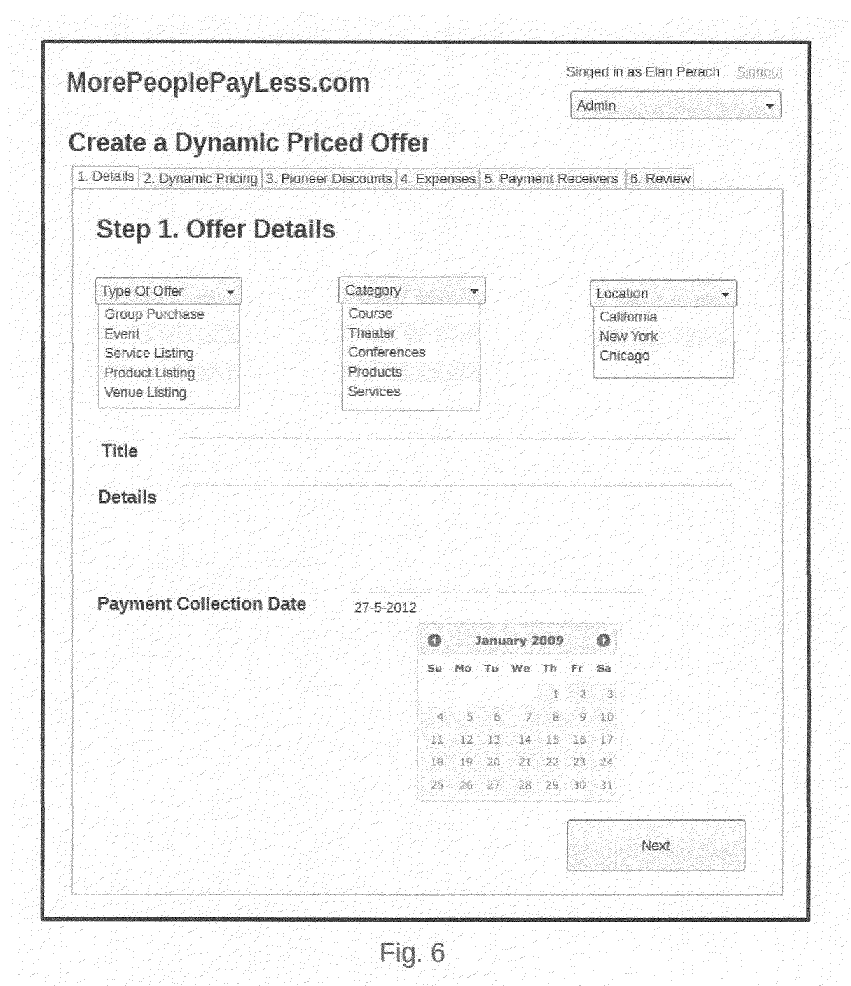

Reference is now made to FIG. 6, which is an example of a screen-shot that describes a dynamic priced offer generation interface. As can be seen, the offer details may include the type of offer, category of offer, location of offer etc., as well as details of the offer and a payment collection date.

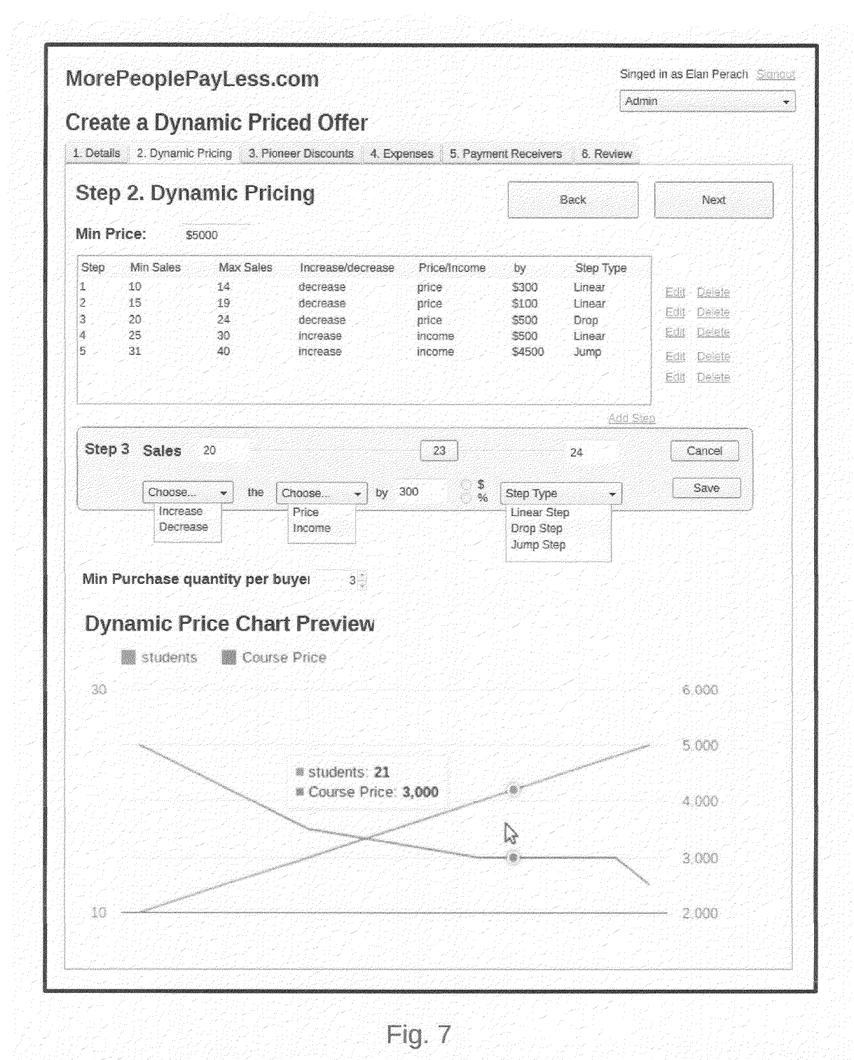

Reference is now made to FIG. 7, which is an example of a screen-shot that describes an example of elements for managing and planning the dynamic price step(s) of an offer. Further, as can be seen, a dynamic price chart preview may be provided, to show the seller a graphic including, for example, the number of buyers (students) of a course, and the changing price of the course.

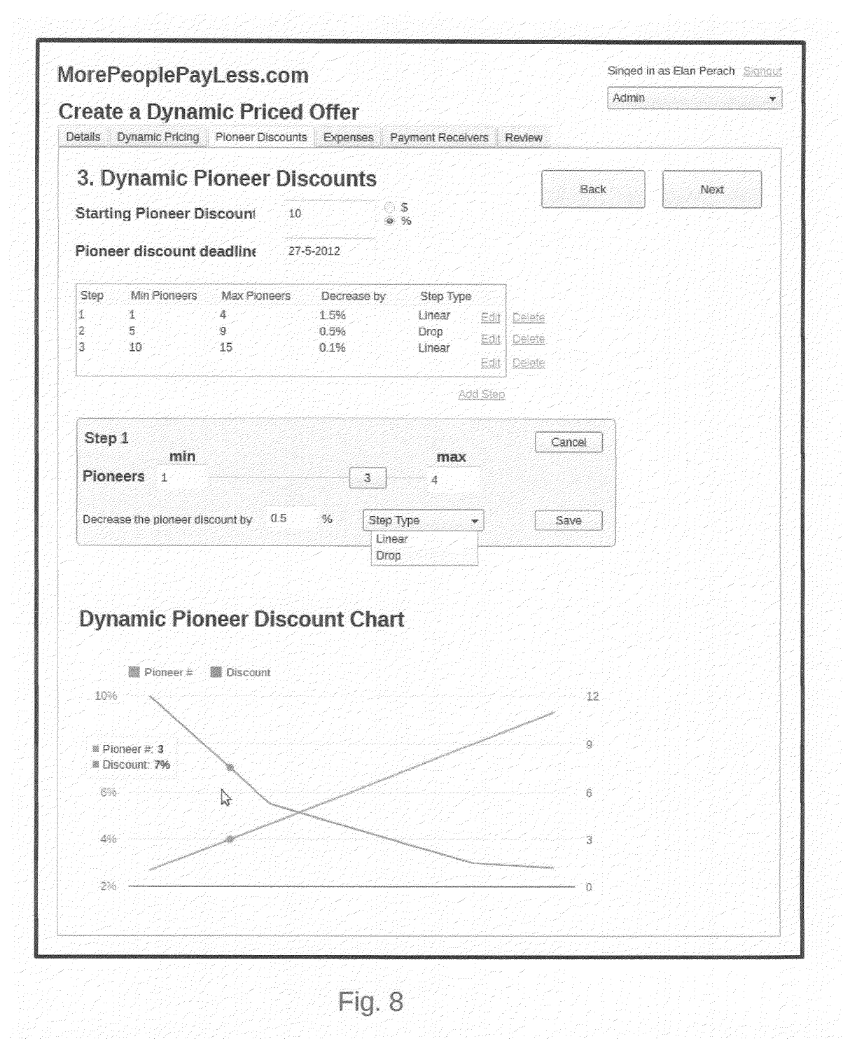

Reference is now made to FIG. 8, which is an example of a screen-shot that describes an example of a pioneer discount pricing setting window. As can he seen, an initial pioneer discount may be set as a percentage or value, along with a discount deadline. The seller, as can be seen, may set various steps at which the discount may change.

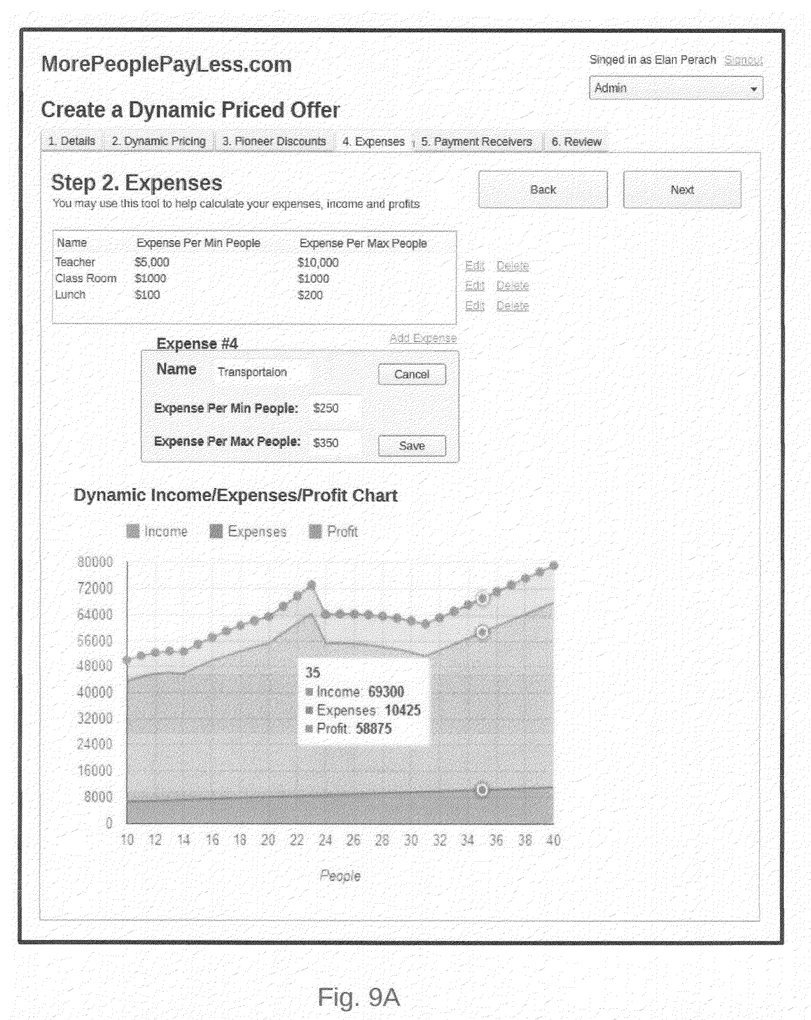

Reference is now made to FIG. 9A, which is an example of a screen-shot that describes an expense management mechanism. As can been in FIG. 9A-9B, the seller may use such a mechanism to calculate relative expenses (per user) and/or absolute expanses (per group) associated with an offer, relative to the number of buyers in order to easily preview their final income, expenses and profit.

In a further example, as can be seen with reference to FIG. 9B, the expense management system may enable Dynamic Expense management, to allow the seller to add dynamic expenses to their calculation in order to preview their final income, expenses and profit, depending on the estimated expenses per number of buyers. As can be seen, the user may drag and drop dynamic points on the chart to determine the expense per number of buyers.

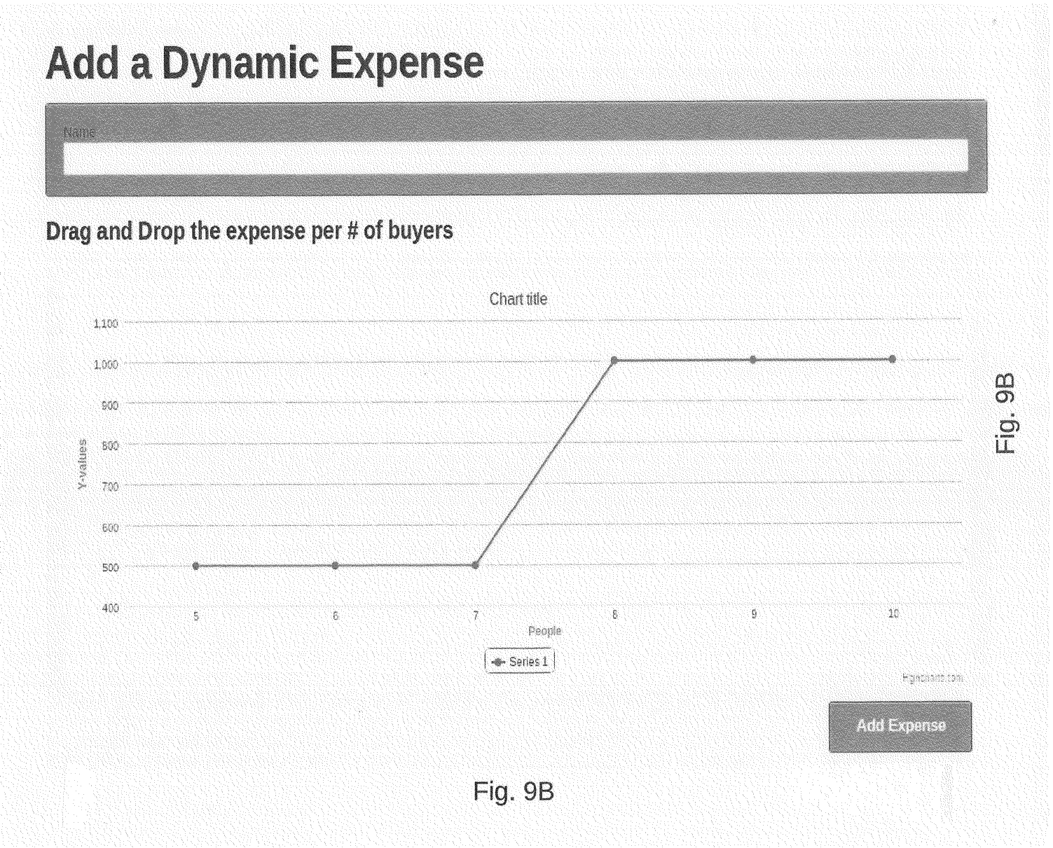

Reference is now made to FIG. 10A, which is an example of a screen-shot that describes a mechanism for organizing and adding multiple payment receivers for an offer. As can been, the seller may use such a mechanism to determine the actual and/or potential fixed or relative payments that will be paid to one or more sellers, receivers, suppliers etc. associated with an offer, relative to the number of buyers.

In still another example, as can be seen in FIG. 10B, the expense management system may enable Dynamic Payment Receiver management, to allow the seller to determine a dynamic income per payment recover. As can be seen, the setter may drag and drop dynamic points on the chart to determine the income per number of buyers.

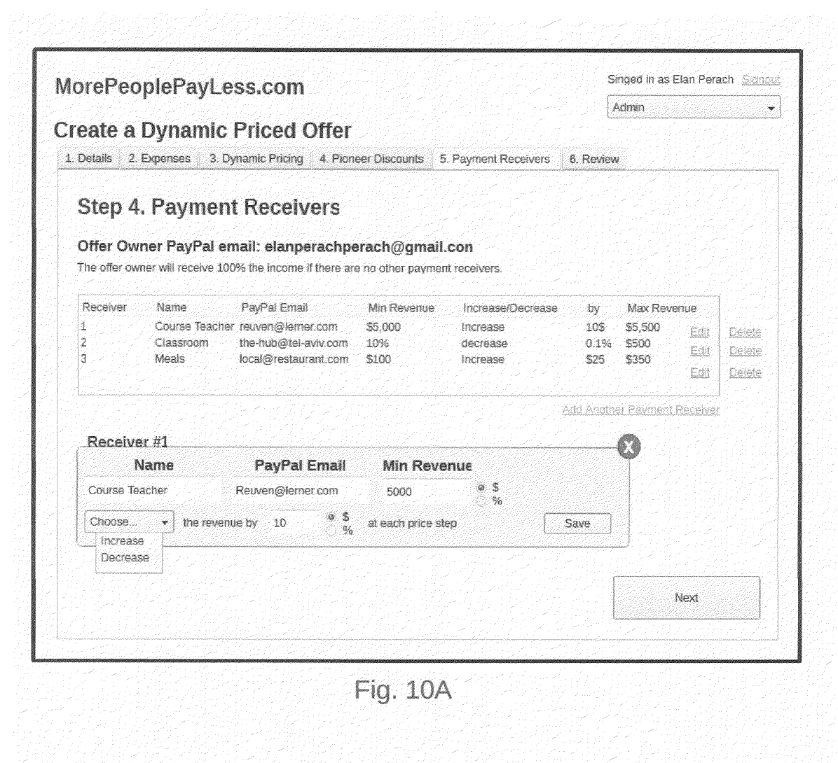

Reference is now made to FIG. 11, which is an example of a screen-shot that describes an example of a course chart income tracking mechanism that integrates the number of buyers, changing prices, and pioneer discounts. The information in the figure may generally be used by a seller to review the offer criteria before launching it to the public.

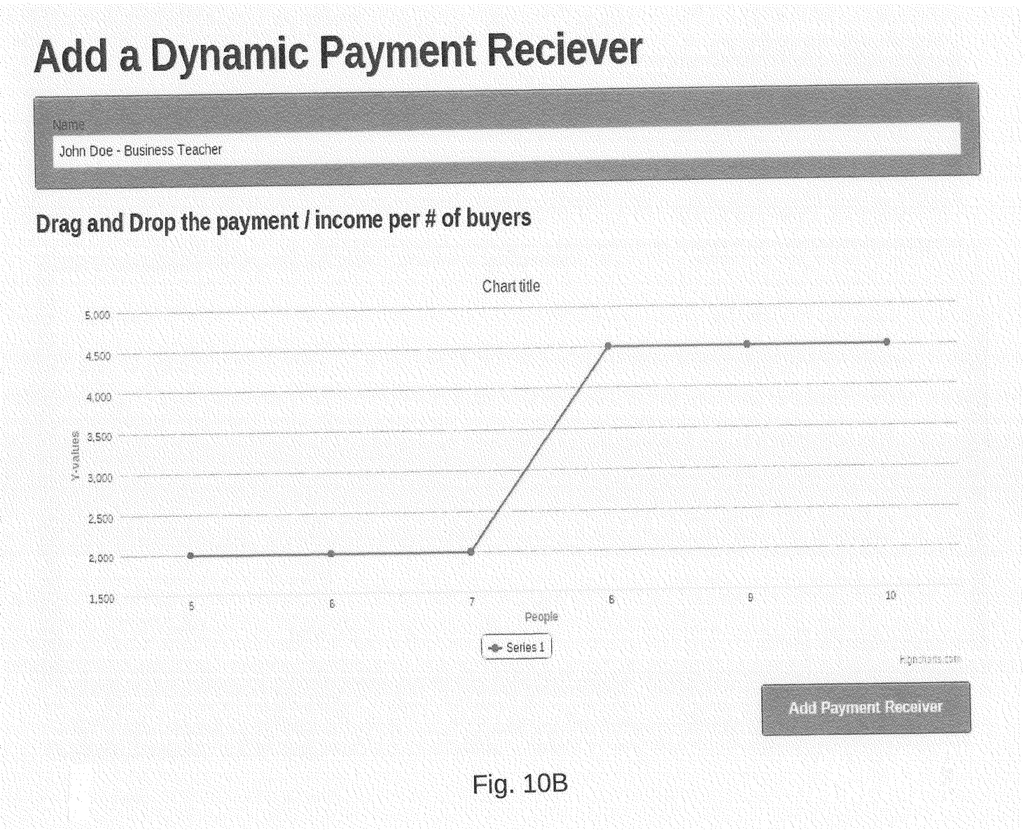

Reference is now made to FIG. 12, which is an example of a screen-shot that describes art example of an offer as it may presented to potential buyers. The figure also introduces the option of entering a conditional pledge and a definite pledge.

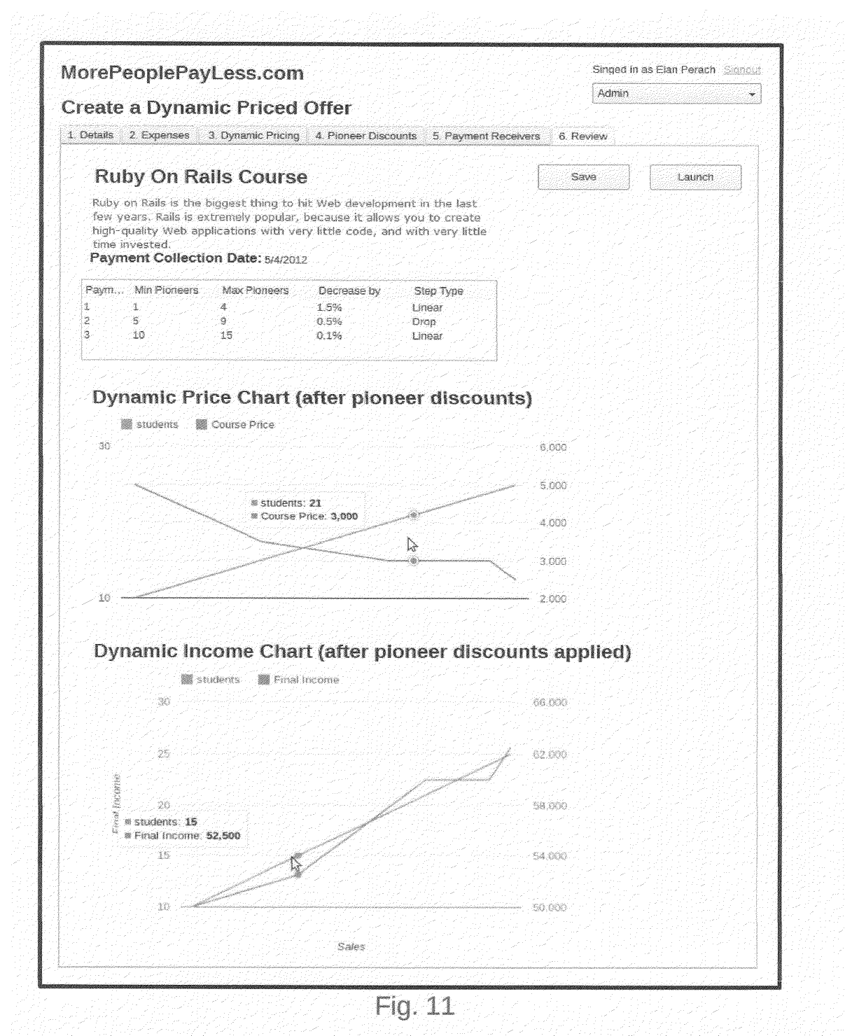

Reference is now made to FIG. 13, which is an example of a screen-shot that describes an example of a pledge tracking mechanism, for example, for potential buyers who are curious to see who has made a pledge.

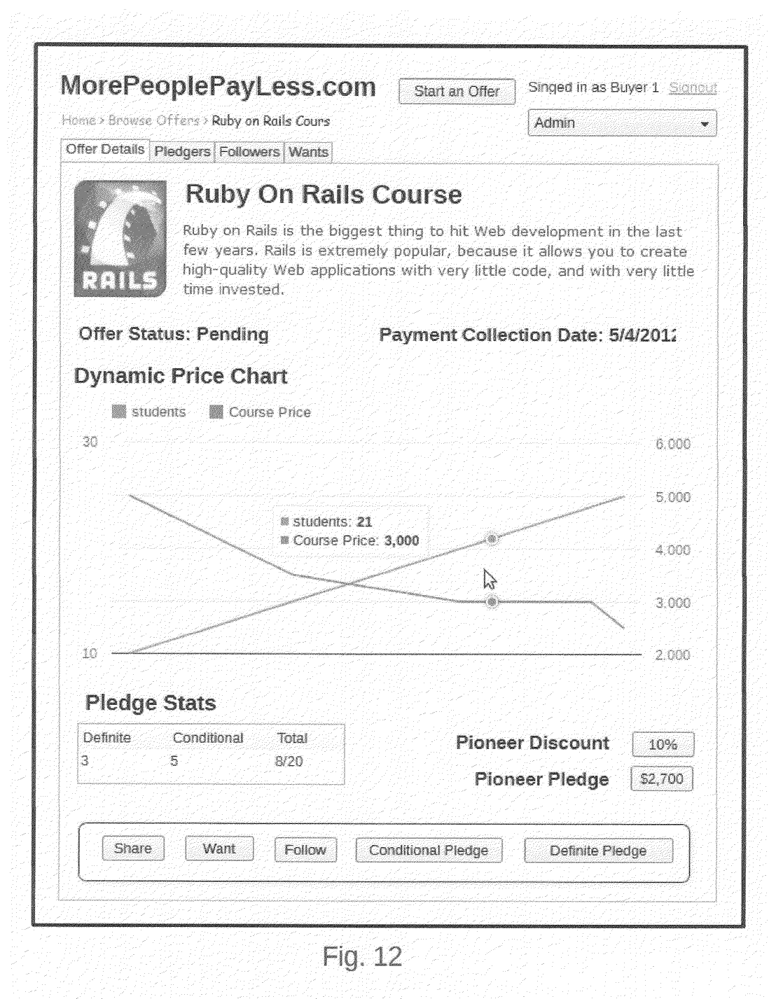

Reference is now made to FIG. 14, which is an example of a screen-shot that describes an example of a course wanting tracking mechanism, in order to track potential buyers who are interested in being sponsored, or to track sponsorship activities. In the example shown, an option is provided to research the buyer by viewing their linkedIn, Facebook, or Google plus profiles etc. In some cases there may also be an option to sponsor one or more potential buyers.

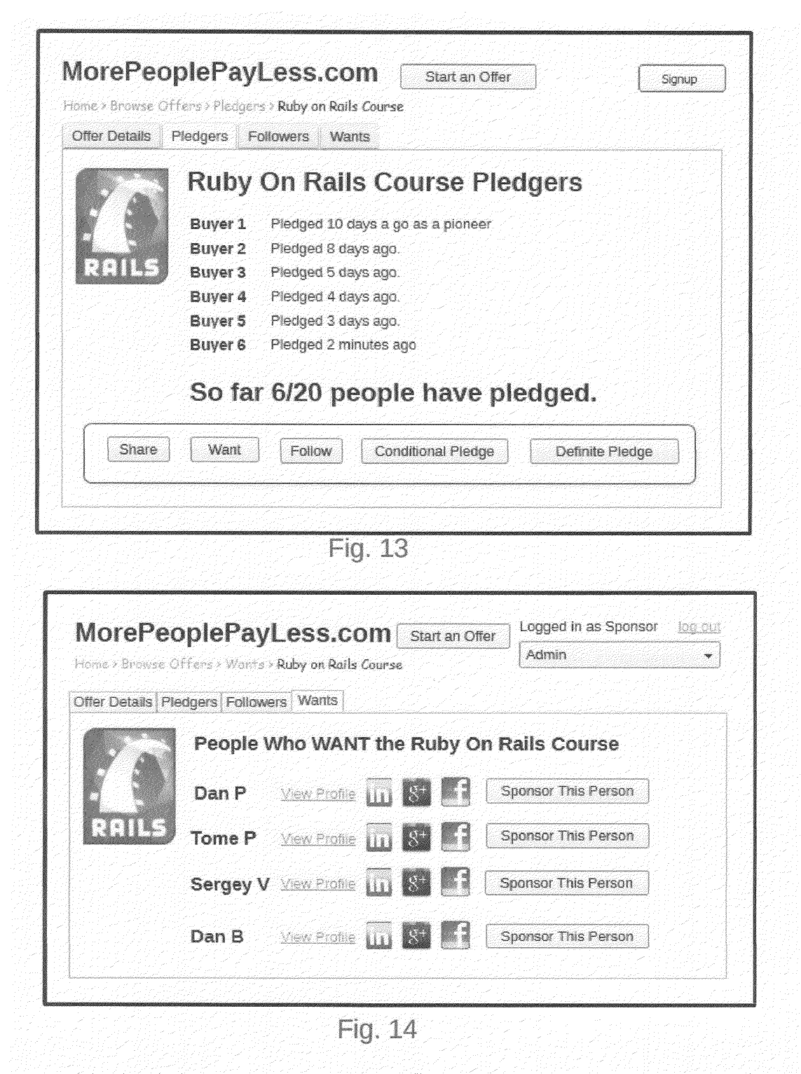

Reference is now made to FIG. 15, which is an example of a screen-shot that describes the sponsorship management mechanism. In the example provided, the sponsor may make a definite or conditional pledge on behalf of the buyer. In some cases, terms and conditions may be provided by a potential sponsor. Further, a mediator may be suggested, for example, from one or more mutual friends, to mediate a settlement in the case of complications.

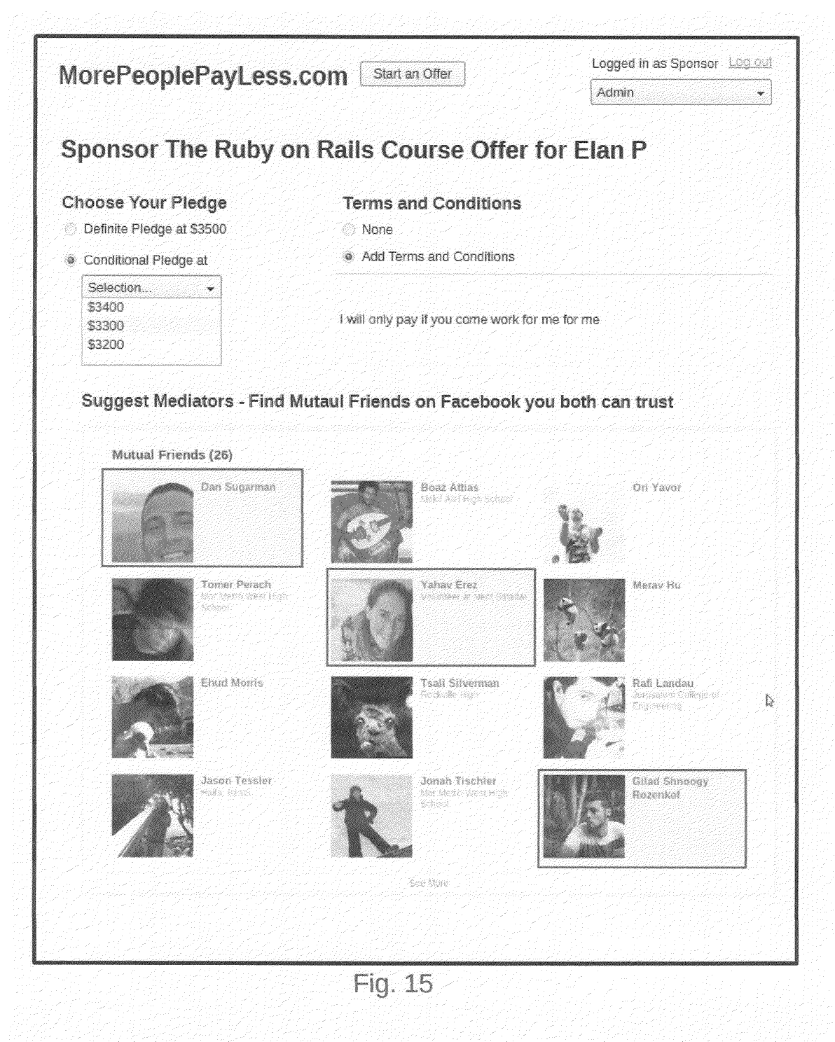

Reference is now made to FIG. 16, which is an example of a screen-shot that describes an example of a dynamic price chart that may be used, for example, for plotting, following and/or managing a definite pioneer pledge. As can be seen the buyer may determine if they intend on paying with cash an amount of pledges they wish to make and a max attendees limit for their pledge.

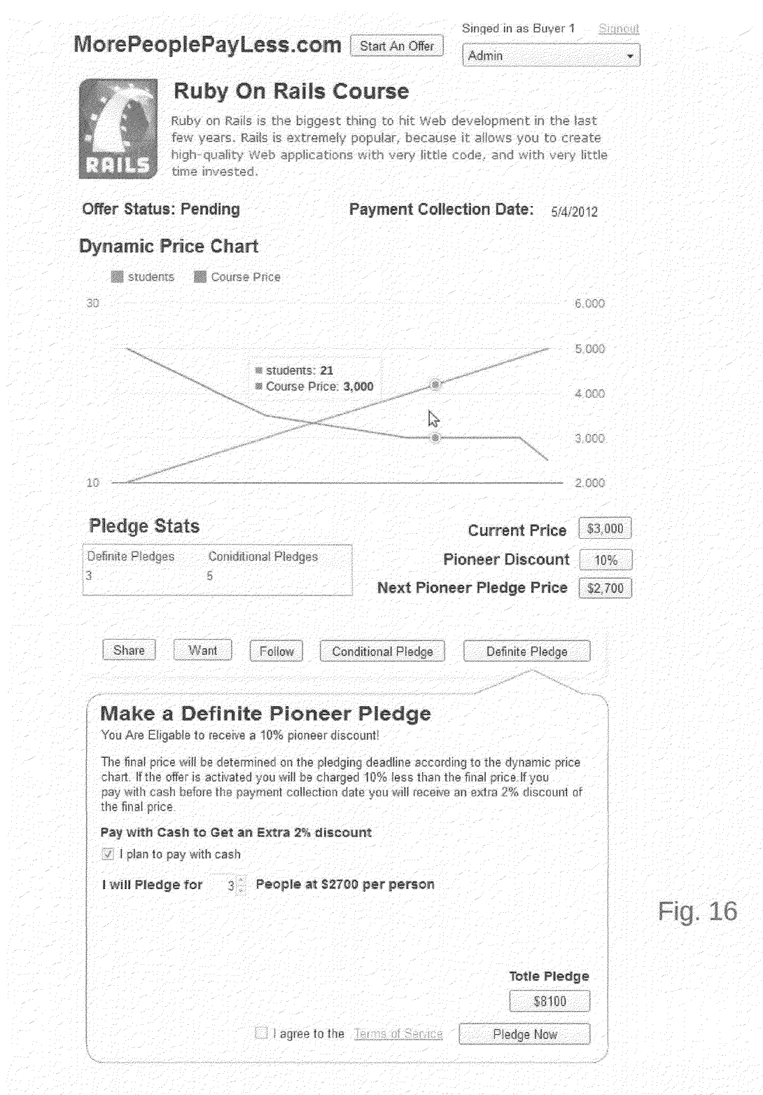

Reference is now made to FIG. 17, which is an example of a screen-shot that describes an example of a tracking mechanism for a Conditional pledge. Where the buyer may determine multiple conditional pledges for various amounts.

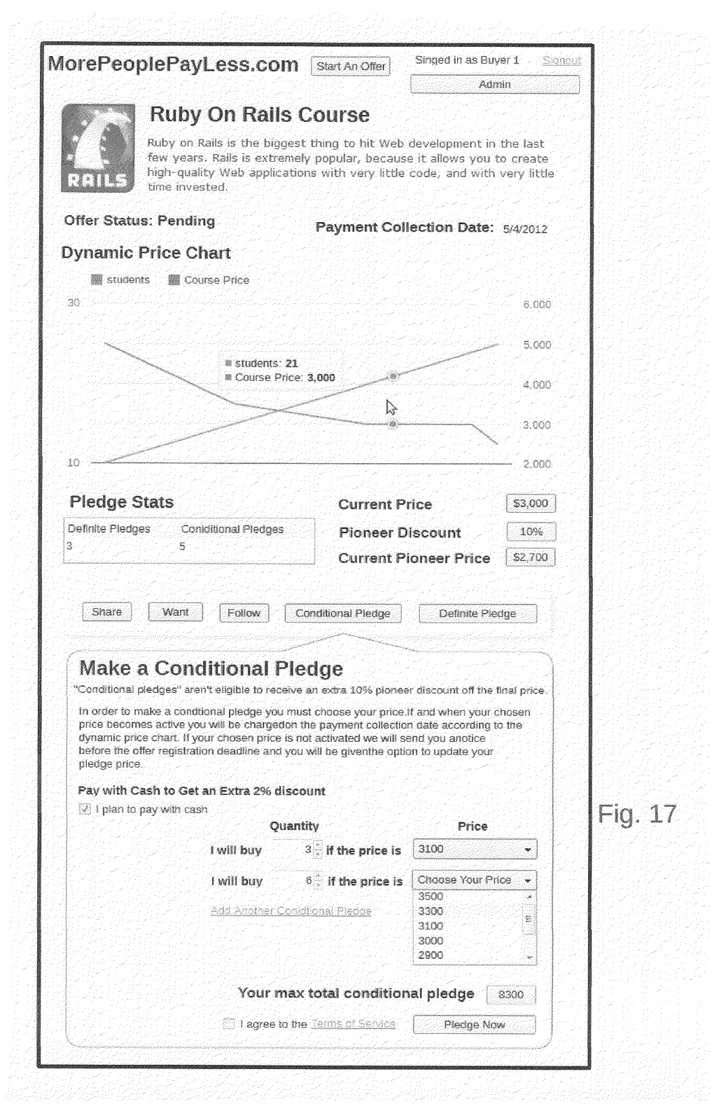

Reference is now made to FIG. 18, is an example of a screen-shot that describes an example of a payment authorization interface, which may optionally be provided by a third party online payment solution. As can be seen, a maximum pre-approved payment may be required, although the final price may be lower than the original pledge depending on the progress of the offer.

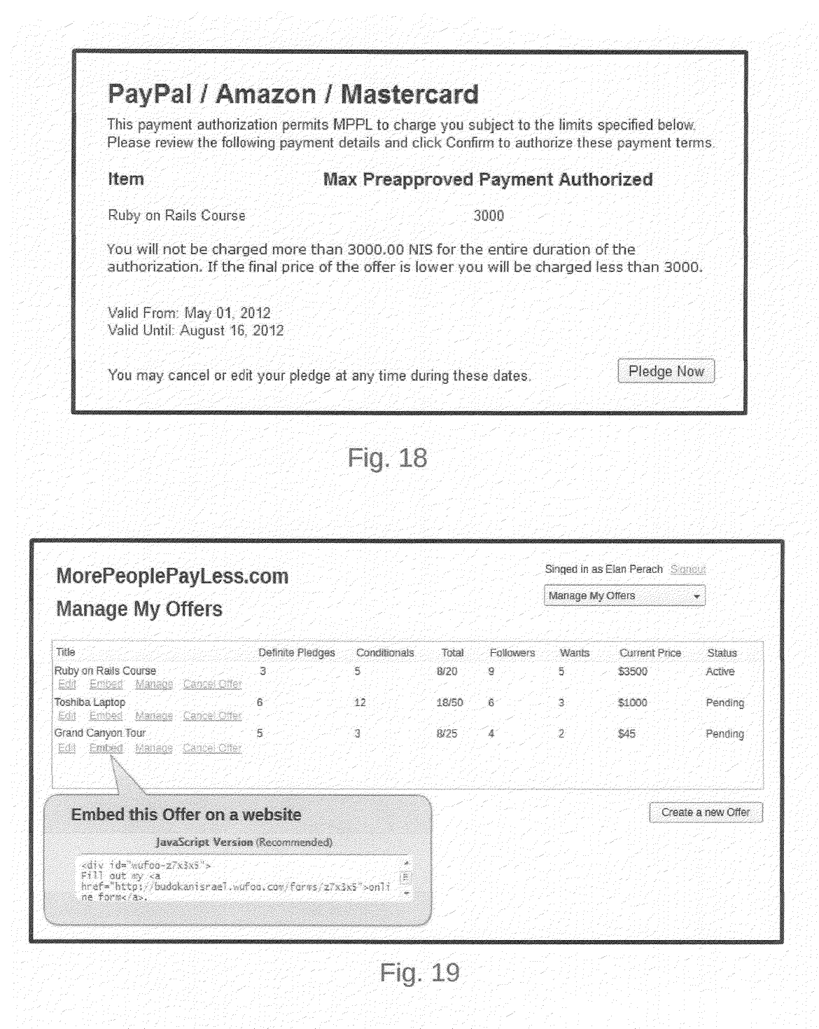

Reference is now made to FIG. 19, which is an example of a screen-shot that describes an example of an offer management tracking mechanism, that integrates the option of embedding the offer in an external location. For example, on the “Offers Management” Page, a seller may grab and copy an embeddable code with which the offer may be placed on at external website, to allow buyers to pledge through the seller's website or any other selected website.

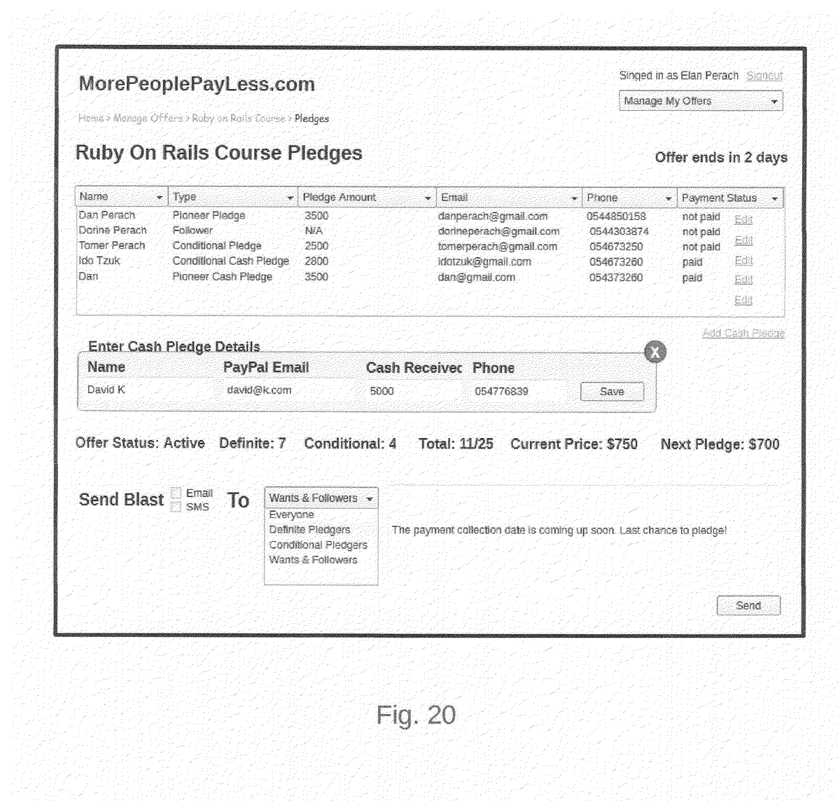

Reference is now made to FIG. 20, which is an example of a screen-shot that describes an example of a pledge management tracking mechanism for a seller, for optionally tracking and updating multiple pledges for an offer. As can be seen, a tool is provided in the offer management section for sending and managing communications with the pledgers by pledge type.

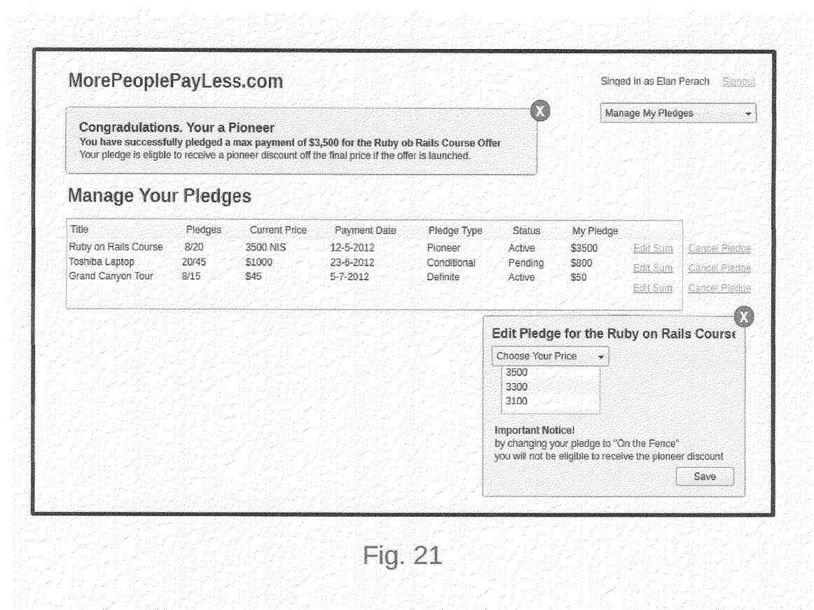

Reference is now made to FIG. 21, which is an example of a screen-shot that describes art example of a pledge management tracking mechanism, for a buyer to manage multiple pledges.

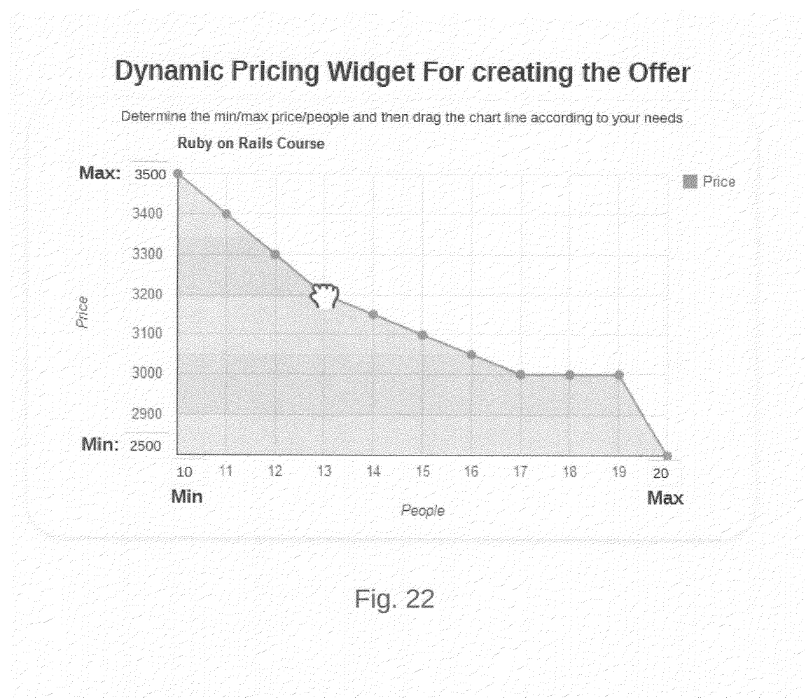

Reference is now made to FIG. 22, which is a screen-shot that describes an example of a dynamic pricing tool for creating an offer. As can be seen, the Dynamic Pricing Chart User Interface for creating an offer provides a tool which makes the process of creating a dynamic priced offer simple. For example, the user may enter the min/max people/price in the corners of the graph and then they may drag the graph points in order to accommodate their income/pricing needs.

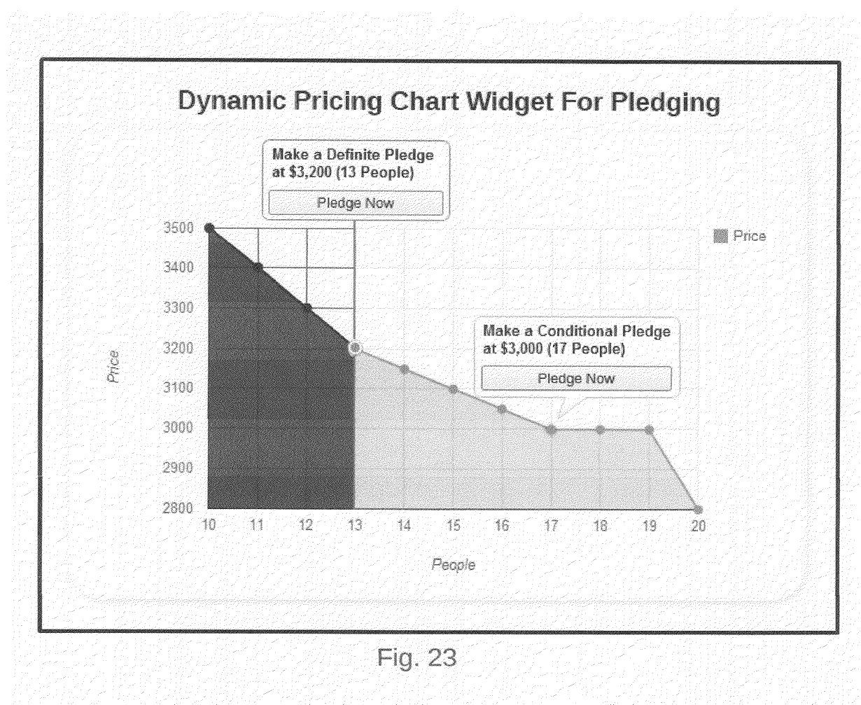

Reference is now made to FIG. 23, which is a screen-shot that describes an example of a dynamic pricing chart tool for a pledger, showing in chart form the respective definite and conditional pledges made. As can be seen, the tool shows the buyer what the “Next Pledge Price” is if they would like to make a definite pledge and they may do so on through the tool. The tool also allows the buyer to hover over the different price steps on the graph and view the various prices at each step, and allows them to choose a price for a conditional pledge using the tool.

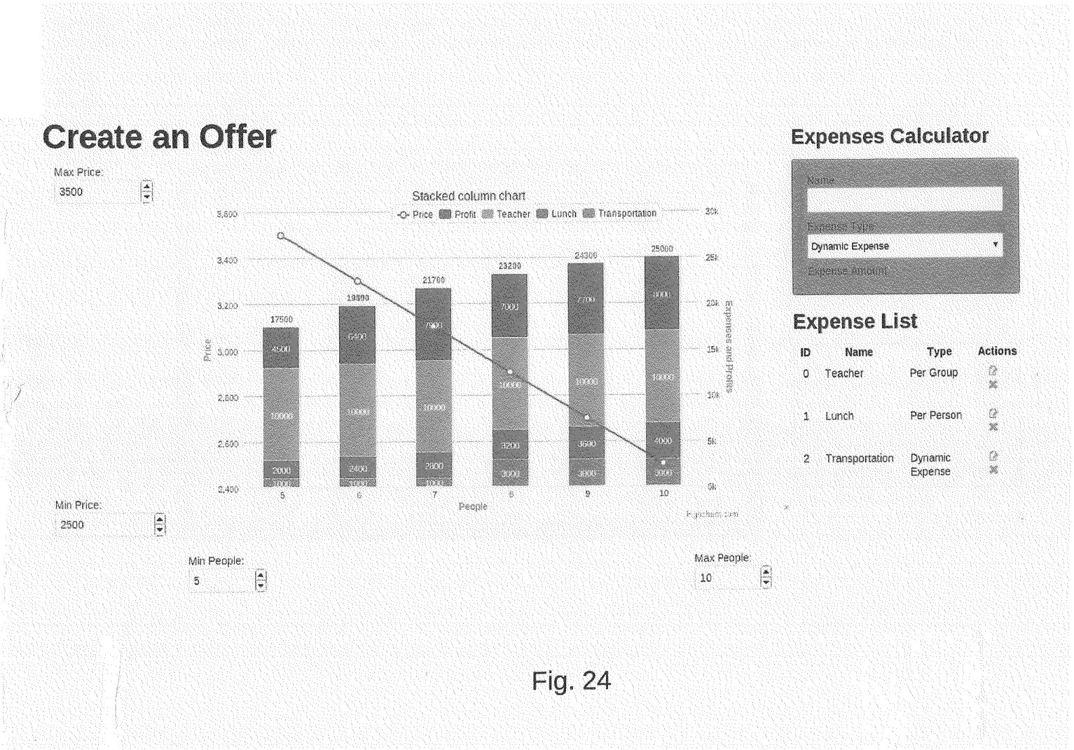

In a further example, as can be seen in FIG. 24, a GUI is provided for Offer creation with a Profit and Loss (PNL) calculator. As can be seen, this tool is designed to help sellers plan the pricing of their offer interactively and visually. Users may, for example, use this tool to drag and drop the price per number of people; increase or decrease the min/max number of people; add an expense per group—meaning an expense that doesn't change according to the number of buyers; add an expense per person—meaning that the expense amount is calculated by multiplying the number of buyers at each price point; and adding a dynamic expense meaning that the seller max drag and drop the expense to any amount per any number of people.

In addition, the tool has a graph that may get updated, for example with bar charts, for each number of potential buyers, while breaking up the different expenses to different colors as well as calculating the final profit and income per number of people in a further example, when a user drags the price at any given number of buyers, the income and profit get automatically updated. In a still further example, a user may hide or show any part of the data on the graph, by clicking the name of the item on top of the chart.

According to some embodiments of the present invention, a method is provided whereby all buyers of an offer pay the same amount, however the price is dynamically effected by the number of buyers, thereby encouraging buyers to purchase together, as well as invite more potential buyers to join together in order to further decrease the price.

In further embodiments, Dynamic Priced Business Process Management is enabled, using a system allowing business or organizations of all sizes to price their services/products/employee salaries/bonuses etc. dynamically. In one example, such pricing may be based on the organization's monthly/yearly income/profit cycles. In a further example, a supermarket may use the system to offer all of products at cost+(e.g., 10%-30% profit margin) according to a monthly income of between $500,000-$2,000,000, such that the employee salaries are based on a base salary plus dynamic bonuses according to the income/profit volume. In this way, the more people who buy from the supermarket on a particular month, the less of a markup they will pay for any product bought.

In yet further embodiments, business transparency may be enabled and promoted, by including in the system described transparency factors. Transparency factors, for example, may allow entities such as companies to easily publicize their financial information such as salaries, expenses, income, profits etc., in order to gain their consumers trust and respect, as well as create a true and meaningful measurement system for consumers to base their choices upon making purchase decisions. For example, when a consumer is looking to decide which supermarket to buy from, they could compare between several supermarket's “buying power”, average monthly/yearly income, how much their top executives are paid and their average profit margin charged on top of their cost etc., thereby empowering the consumer to make a calculated decision of which supermarket they want to “invest” their spending. In still additional examples, an online marketplace may be modified with advanced features, for example, allowing consumers to compare businesses and make calculated purchases based on true financial information presented in an easy to compare manner.

In still further embodiments a “SAP” style SAAS platform is provided for businesses to manage their inventory expenses, employee salaries, income and profits etc in a “dynamic” fashion, as a back-end system. In the front-end, the current embodiment may enable a business to be able to setup point-of-sale stations using mobile computers to allow easy integration as well as a possibility to provide an online e-commence website with their own custom domain which is connected to the back-end.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is therefore, to be understood that the appended claims are intended to over all such modifications and changes as fall within the true spirit of the invention.

What is claimed is:

1. A dynamic price offered management system, comprising:
an end user communication device in data connection with the system server, said server including a file with instructions to execute commands to enable execution of the offer management;
a system database including a memory having stored thereon system data, offer data, and user data;
a dynamic pricing module including instructions to execute commands to enable dynamic price offer management; and
a conditional pledging module including instructions to execute commands to enable conditional pledging.

2. The system of claim 1, further comprising an offer sponsorship module including instructions to execute commands to enable offer sponsorship management.

3. The system of claim 1, further comprising a marketplace adapted to allow merchants to collect revenues from dynamic priced offers.

4. The system of claim 1, further comprising a dynamic discounting module.

5. The system of claim 1, further comprising a dynamic expense management module.

6. The system of claim 1, further comprising a dynamic payment receiver module.

7. A method for enabling dynamic priced offer management, comprising running one or more files with instructions to execute commands to enable conditional pledging, including:
generating a purchase offer, by a seller;
generating a purchase pledge(s), by a potential buyer;
querying, on the payment collection date, whether the offer requirements, and/or the pledge conditions, are met;
if the offer requirements are met, then calculating how many applicable pledges meet the requirements, and calculating the final puce per buyer, and
if the offer requirements are not met, then the system ends the offers process with no deal.

8. The method of claim 7, further comprising charging buyers together and transferring the funds to the seller(s).

9. The method of claim 7, further comprising querying whether one or more buyers have a pioneer discount, a cash discount, and/or other price changing element.

10. The, method of claim 9, wherein said pledge may include one or more of pioneer pledges, definite pledges, pledges wanted, max attendees limit and/or an offer follow requirement.

11. The method of claim 7, wherein said potential buyer pledges may optionally include one or more pledge conditions.

12. The method of claim 7, wherein said potential buyer stipulates multiple possible conditions which must be met in order for the pledge to be executed.

13. The method of claim 7, wherein a sponsor makes a pledge on behalf of one or more buyers.

14. The method of claim 13 wherein said sponsor generates related terms and conditions for executing said pledge on behalf of a buyer.

15. The method of claim 7, wherein multiple potential buyers choose the maximum price they are willing to pay, wherein only if their conditions are met will their payment be charged.

16. The method of claim 7, further comprising adding one or more dynamic expenses to said purchase offer.

17. The method of claim 7, further comprising adding one or more dynamic payment receivers to said purchase offer.

18. An e-commerce tool for enabling dynamic price offer generation, comprising:
an interactive dynamic graphical interface including a dynamic drag and drop feature for determining the price of the offer per number or buyers;
is range input tool to enable the minimum and maximum number of buyers; and
a profit calculation tool including an expense calculator to provide a graphical interface to display planned profits for the offer per number of buyers.

19. The tool of claim 18, wherein said expense calculator is a dynamic expense interface based on a selected expense level for a selected number of buyers.
